(19) United States
(12) Patent Application Publication
(10) Pub. No.: US 2019/0210493 A1
(43) Pub. Date: Jul. 11, 2019

(54) CHILD RESTRAINT WITH MOVABLE HEADREST

(71) Applicant: Dorel Juvenile Group, Inc., Foxboro, MA (US)

(72) Inventor: Gordon WOODS, Nauvoo, AL (US)

(21) Appl. No.: 16/244,343

(22) Filed: Jan. 10, 2019

Related U.S. Application Data
(60) Provisional application No. 62/615,580, filed on Jan. 10, 2018.

(51) Int. Cl. B60N 2/28; B60N 2/885; B60N 2/809

(52) U.S. Cl. CPC B60N 2/2851; B60N 2/809; B60N 2/885; B60N 2/286

(57) ABSTRACT

A juvenile vehicle seat includes a seat bottom and a backrest associated with the seat bottom. A headrest is movable relative to the backrest to support the head of a child seated on the seat bottom.

### PRIORITY CLAIM

This application claims priority under 35 U.S.C. § 119(e) to U.S. Provisional Application No. 62/615,580, filed Jan. 10, 2018, which is expressly incorporated by reference herein.

### BACKGROUND

The present disclosure relates to a child restraint and particularly to a juvenile vehicle seat including a seat bottom and a seat back. More particularly, the present disclosure relates to a seat back of a juvenile vehicle seat that includes a backrest and a movable headrest.

### SUMMARY

A juvenile vehicle seat in accordance with the present disclosure upwardly from the seat bottom. The seat back includes a backrest associated with the seat bottom and a movable headrest mounted for up-and-down movement relative to the backrest in directions towards or away from the seat bottom.

In illustrative embodiments, the seat back includes a headrest-height adjuster located between a front side of the backrest and a rear side of the movable headrest. The headrest-height adjuster includes a headrest-motion guide track coupled to the front side of the backrest and a companion slidable guide-track mount coupled to a rear side of the movable headrest. The slidable guide-track mount is mated to the headrest-motion guide track to allow up-and-down movement of the movable headrest relative to the backrest at the option of a caregiver.

In illustrative embodiments movable headrest will generally remain in an elevated position selected by the caregiver above the underlying seat bottom owing to the frictional engagement at a frictional interface provided between the slidable guide-track mount and the headrest-motion guide track. While such frictional engagement serves to retain the movable headrest temporarily in a selected positon on the backrest it is not sufficient to block or otherwise hinder up-and-down movement of the movable headrest under the control of a caregiver. This allows the caregiver to apply either an upwardly directed external force or a downwardly directed external force to the movable headrest to adjust the height of the movable headrest relative to the seat bottom to suit the needs of an occupant of the juvenile vehicle seat.

In illustrative embodiments, the seat back further includes a headrest-motion controller coupled to the movable headrest and to the headrest-height adjuster. The headrest-motion controller includes a top motion limiter associated with an upper portion of the movable headrest and a bottom motion limiter associated with a lower portion of the movable headrest. The headrest-motion controller also includes an upper stop associated with an upper portion of the backrest and a lower stop associated with a middle portion of the backrest and located between the upper stop and the seat bottom. In use, the bottom motion limiter associated with the movable headrest engages the upper stop associated with the backrest to limit upward movement of the movable headrest away from the seat bottom. The top motion limiter associated with the movable headrest engages the lower step associated with the backrest to limit downward movement of the movable headrest toward the seat bottom.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a child restraint including a headrest-height adjuster in accordance with the present disclosure and suggesting that a seat back included in a juvenile vehicle seat of the child restraint includes a backrest, a movable headrest, and a headrest-height adjuster configured to provide a frictional interface located between the backrest and the movable headrest and showing the movable headrest in a raised position on an upper portion of the backrest and suggesting that the headrest-height adjuster incudes a headrest-motion guide track coupled to the backrest and a slidable guide-track mount coupled to the movable headrest and arranged to engage the headrest-motion guide track at the frictional interface;

FIG. 2 is a perspective view similar to FIG. 1 showing the movable headrest in a lowered position on the backrest after a caregiver has applied a downwardly directed external force to the headrest to overcome frictional resistance to motion extant at the frictional interface to cause the headrest to move relative to the backrest in a downward direction from the raised position shown in FIG. 1;

FIG. 3 is a front perspective view of the backrest of the juvenile vehicle seat before the movable headrest is installed and showing that the headrest-height adjuster includes a vertically extending headrest-motion guide track mounted on a front side of the backrest and suggesting that the seat back further includes a headrest-motion controller comprising an upper stop associated with an upper portion of the backrest and a lower stop associated with a middle portion of the backrest;

FIG. 4 is an enlarged rear elevation view of an illustrative embodiment of the movable headrest of FIGS. 1 and 2 showing that a slidable guide-track mount is coupled to a rear side of the movable headrest and configured to mate with the headrest-motion guide shown in FIG. 3 to establish the frictional interface therebetween as suggested diagrammatically in FIG. 1 and suggesting that the headrest-motion controller also includes a top motion limiter associated with an upper portion of the movable headrest and a bottom motion limiter associated with a lower portion of the movable headrest;

FIG. 5 is an enlarged perspective view showing one way that the slidable guide-track mount can be mated to the headrest-motion guide track to support the movable headrest for selective up-and-down movement relative to the backrest to change the elevation of the movable headrest relative to the underlying seat bottom; and

FIG. 6 is an enlarged sectional view taken along line 6-6 of FIG. 5 showing that the headrest-motion guide track includes a strip anchor having one end coupled to the backrest and another end coupled to a junction formed between the first and second strips.

### DETAILED DESCRIPTION

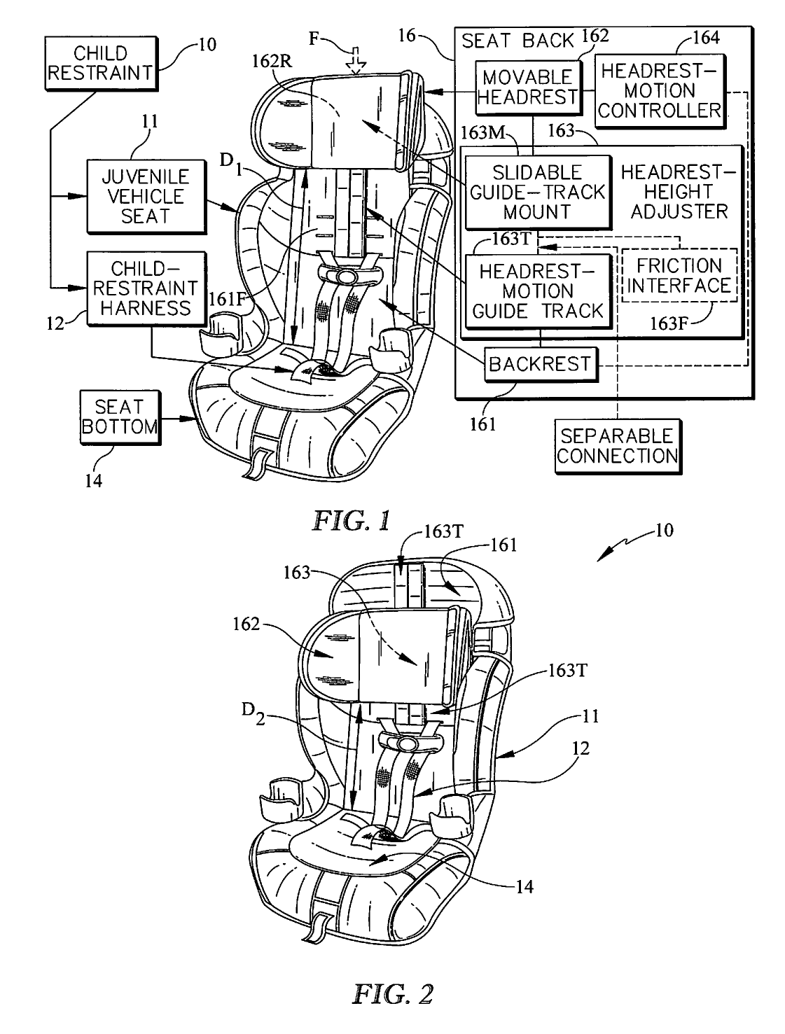

A child restraint 10 comprises a juvenile vehicle seat 11 including a headrest-height adjuster 163 in accordance with the present disclosure and a child-restraint harness 12 coupled to juvenile vehicle seat 11 as shown, for example, in FIG. 1. Juvenile vehicle seat 11 includes a seat bottom 14 and a seat back 16 arranged to extend upwardly from seat bottom 14. Seat back 16 includes a backrest 161 coupled to seat bottom 14, a movable headrest 162 arranged to lie above seat bottom 14 and in front of an upper portion 161U of backrest 161, and headrest-height adjuster 163 as suggested in FIG. 1.

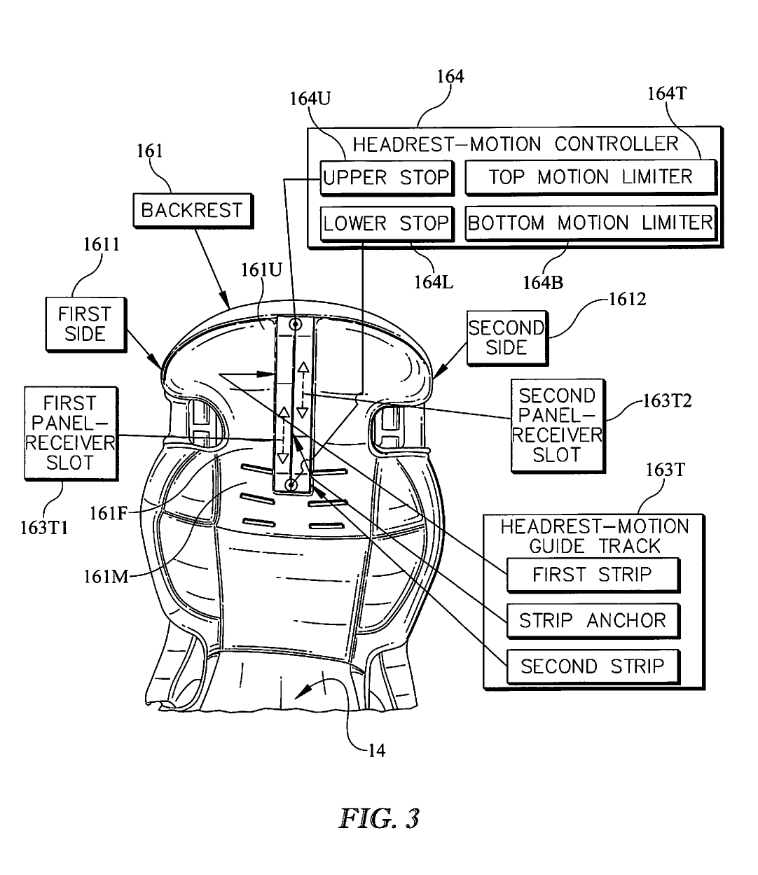

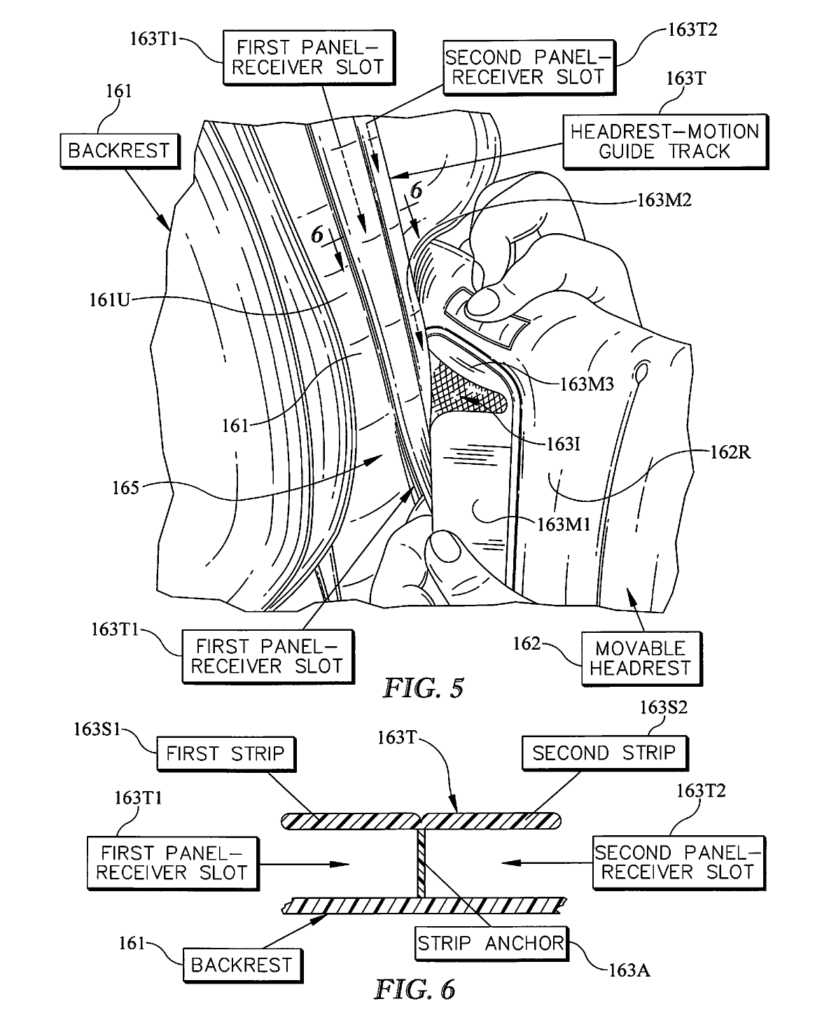

Headrest-height adjuster 163 is configured to establish a frictional interface 163F that functions to retain the movable headrest 162 at a selected elevation on backrest 161 until an external friction-overcoming force (F) is applied by a caregiver to the movable headrest 162 to cause headrest 162 to move upwardly or downwardly on backrest 161. A headrest-motion guide track 163T is coupled to backrest 161 as shown in FIG. 3 and releasably mated to a slidable guide-track mount 163M that is coupled to the movable headrest 162 as shown in FIG. 5 to form headrest-height adjuster 163 and to establish a frictional interface 163F between headrest-motion guide track 163T and the slidable guide-track mount 163M as suggested diagrammatically in FIG. 1.

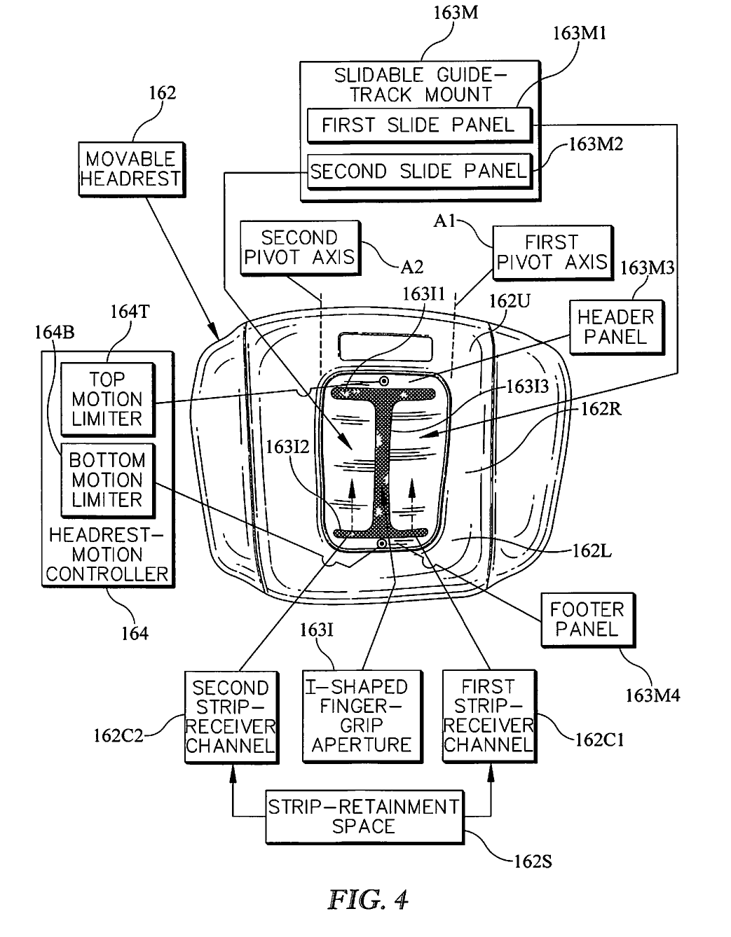

Seat back 16 further includes a headrest-motion controller 164 coupled to the movable headrest 162 and to headrest-height adjuster 163 as suggested in FIGS. 1, 3 and 4. Headrest-motion controller 164 includes a top motion limiter 164T associated with an upper portion 162U of the movable headrest 162 and a bottom motion limiter 164B associated with a lower portion 162L of the movable headrest 162 as suggested in FIG. 4. Headrest-motion controller 164 also includes an upper stop 164U associated with upper portion 161U of backrest 161 and a lower stop 164L associated with a middle portion 161M of backrest 161 as suggested in FIG. 3. Lower stop 164L is located between upper stop 164U and seat bottom 14. In use, the bottom motion limiter 164B associated with the movable headrest 162 engages the upper stop 164U associated with the backrest 161 to limit upward movement of the movable headrest 162 away from the seat bottom 14. The top motion limiter 164T associated with the movable headrest 162 engages the lower stop 164L associated with the backrest 161 to limit downward movement of the movable headrest 162 toward the seat bottom 14.

Headrest-height adjuster 163 is configured to lie in a space 165 provided between the movable headrest 162 and upper portion 161U of backrest 161 as suggested diagrammatically in FIG. 1 and illustratively in FIG. 5. Headrest-motion guide track 163T cooperates with the slidable guide-track mount 163M to provide means for supporting the movable headrest 162 for up-and-down movement relative to backrest 161 between a raised position arranged to support the head of a taller child (not shown) seated on seat bottom 14 as suggested in FIG. 1 and a lowered position arranged to support the head of a relatively shorter child (not shown) as suggested in FIG. 2. A caregiver can separate the slidable guide-track mount 163M from headrest-motion guide track 163T in accordance with the present disclosure as suggested diagrammatically in FIG. 1 and illustratively in FIG. 5 so that the movable headrest 162 can be separated from backrest 161 and later re-installed.

Headrest-height adjuster 163 comprises a headrest-motion guide track 163T coupled to a front side 161F of the stationary backrest 161 as shown diagrammatically in FIG. 1 and illustratively in FIG. 3 and a slidable guide-track mount 163M coupled to rear side 162R of the movable headrest 162 as shown diagrammatically in FIG. 1 and illustratively in FIG. 4. Headrest-height adjuster 163 is assembled by mating the rearwardly extending slidable guide-track mount 163M that is carried on the movable headrest 162 with the forwardly extending headrest-motion guide track 163T that is carried on the backrest 161.

The slidable guide-track mount 163M can be flexed and mated with headrest-motion guide track 163T as shown, for example, in FIG. 5 to support the movable headrest 162 for up-and-down movement relative to backrest 161 between the raised position shown in FIG. 1 and the lowered position shown in FIG. 2. It is also within the scope of the present disclosure to provide upper and lower guide-track insertion (panel receiver) slots 163T1, 163T2 that are sized to receive portions (e.g. slide panels 163M1, 163M2) of the headrest-motion guide track 163T therein during sliding movement of the movable headrest 162 along front side 161F of backrest 161 to facilitate headrest 162 engagement to and disengagement from headrest-motion guide track 163T on backrest 161.

As shown in FIG. 3, headrest-motion guide track 163T includes a first strip 163S1 arranged to lie in a vertical orientation on upper portion 161U of backrest 161 and a second strip 163S2 arranged to lie in side-by-side relation to first strip 163S1 also in a vertical orientation on upper portion 161U of backrest 161. A rearwardly extending strip anchor 163A is used to anchor the first and second strips 163S1, 163S2 to a forwardly facing surface of upper portion 161U of backrest 161 to establish a vertically extending first side-opening panel-receiver slot 163T1 under the first strip 163S1 and a separate vertically extending second side-opening panel-receiver slot 163T2 under the second strip 163S2. The slots 163S1, 163S2 open sideways in opposite directions as suggested in FIG. 3 so that the first panel-receiver slot 163S1 opens in a first direction toward a first side 1611 of backrest 161 and the second panel-receiver slot 163S2 opens in an opposite second direction toward a second side 1612 of the backrest 161.

As shown in FIG. 4, slidable guide-track mount 163M includes a first slide panel 163M1 that is mounted on rear side 162R of the movable headrest 162 for movement about a vertically extending first pivot axis Al (shown in FIG. 4) as suggested in FIG. 5. The slidable guide-track mount 163M also includes an opposing second slide panel 163M2 that is mounted on rear side 162R of the movable headrest 162 for movement about a vertically extending second pivot axis A2 shown in FIG. 4. As suggested in FIG. 4, first and second pivot axes A1, A2 are arranged to lie in spaced-apart parallel relation to one another to allow the first and second slide panels 163M1, 163M2 to extend toward one another and form a vertically extending caregiver-finger insertion slot 163I3 therebetween.

First slide panel 163M1 can be pivoted on first pivot axis A1 in a clockwise direction (when viewed from above) to move away from the movable headrest 162 as suggested in FIG. 5 to allow a free end of that first slide panel 163M1 to be extended into the first-panel receiver slot 163T1 associated with first strip 163S1 of headrest-motion guide track 163T during coupling of the slidable guide-track mount 163M on the movable headrest 162 to headrest-motion guide track 163T on backrest 161 to support the movable headrest 162 for up-and-down movement on backrest 161. Second slide panel 163M2 can be pivoted on second pivot axis A2 in a counterclockwise direction (when viewed from above) to move away from the movable headrest 162 to allow a free end of that second slide panel 163M2 to be extended into the second panel-receiver slot 163T2 associated with second strip 163S1 of headrest-motion guide track 163T during coupling of the slidable guide-track mount 163M to the headrest-motion guide track 163T at a seat-assembly factory by a factory worker or machine or in the field by a caregiver. Once these slide panel couplings are accomplished, the movable headrest 162 is free to slide up and down on headrest-motion guide track 163T at the option of a caregiver. Friction between the mating components 163T, 163M included in the headrest-height adjuster 163 will cause the movable headrest 162 to remain temporarily in a stationary position along the headrest-motion guide track 163T selected by the caregiver until the caregiver elects to apply an external force (F) to the movable headrest 162 to cause the movable headrest 162 to move to a new vertical position.

First and second slide panels 163M1, 163M2 of the slidable guide-track mount 163M cooperate with an opposing rearwardly facing portion 162R of the movable headrest 162 to form a strip-retainment space 162S as suggested in FIGS. 4 and 5. Strip-retainment space 162S is configured to contain portions of first and second strips 163S1, 163S2 of headrest-motion guide track 163T yet allow movement of first and second slide panels 163M1, 163M2 of the slidable guide-track mount 163M relative to the strips 163S1, 163S2 of headrest-motion guide track 163T during up-and-down movement of the movable headrest 162 on the headrest-motion guide track 163T.

First and second slide panels 163M1, 163M2 cooperate with companion header and footer panels 163M3, 163M4 also included in the slidable guide-track mount 163M to form an I-shaped aperture 163I opening into strip-retainment space 162S as suggested in FIG. 4. Header and footer panels 163M3, 163M4 are arranged to lie in vertically spaced-apart relation to one another to locate the pivotable first and second slide panels 163M1, 163M2 therebetween as shown in FIG. 4. The I-shaped aperture 163I comprises horizontally extending upper and lower guide-track insertion slots 163I1, 163I2 and a vertically extending caregiver-finger insertion slot 163I3 that interconnects the upper and lower guide-track insertion slots 163T1, 163T2. The horizontally extending upper and lower guide-track insertion slots 163I1, 163I2 cooperate to provide means for slidably receiving the first and second strips 163S1, 163S2 of the headrest-motion guide track 163T therein to allow up-and-down movement of the movable headrest 162 relative to backrest 161 between the raised position shown in FIG. 1 and the lowered position shown in FIG. 2.

In an illustrative embodiment, each of the first and second strips 163S1, 163S2 included in headrest-motion guide track 163T includes a core made of a polypropylene material and an outer covering made of fabric. The first and second slide panels 163M1, 163M2 included in the slidable guide-track mount 163M are made of an elastic deformable material and are flexible to encase the first and second strips 163S1, 16IS2 of headrest-motion guide track 163T. The elastic deformable material may include a core made of a polypropylene material and an outer covering made of fabric. These slide panels 163M1, 163M2 are rigid enough to maintain their shape and position relative to one another during up-and-down movement of the movable headrest 162 on headrest-motion guide track 163T so that the strips 163S1, 163S2 of headrest-motion guide track 163T do not inadvertently slide out of strip-retainment space 162S during up-and-down movement of the movable headrest 162 relative to those strips 163S1, 163S2.

The movable headrest 162 remains attached to headrest-motion guide track 163T until removed by a caregiver. A caregiver may separate the movable headrest 162 from headrest-motion guide track 163T by withdrawing first and second strips 163S1, 163S2 of headrest-motion guide track 163T from the strip-retainment space 162S provided between the movable headrest 162 and the first and second slide panels 163M1, 163M2 using any suitable technique. One way to accomplish this headrest removal in accordance with the present disclosure is to slide the headrest 162 upwardly away from the seat bottom 161 to cause the strips 163S1, 163S2 to exit the strip-retainment space 162S through the horizontally extending upper guide-track insertion slot 163I1 of the I-shaped aperture 163I. Another way is to slide the headrest 162 downwardly toward the seat bottom 14 to cause the strips 163S1, 163S2 to exit the strip-retainment space 162S through the horizontally extending lower guide-track insertion slot 163I2 of the I-shaped aperture 163I. Another way to accomplish headrest removal in accordance with the present disclosure is the reverse of what is shown in FIG. 5 in which the caregiver first withdraws the first slide panel 163M1 from the first panel-receiver slot 163T1 formed between the backrest 161 and the first strip 163S1 of the headrest-motion guide track 163T and then withdraws the second slide panel 163M2 from the second panel-receiver slot 163T2 formed between the second strip 163S2 of the headrest-motion guide track 163T (or vice versa).

As suggested in FIG. 3, upper stop 164U of headrest-motion controller 164 is mounted on an upper portion of headrest-motion guide track 163T. It is also within the scope of the present disclosure to mount upper 164U stop on a neighboring portion of backrest 161.

As suggested in FIG. 3, lower stop 164L of headrest-motion controller 164 is mounted on a lower portion of headrest-motion guide track 163T. It is also within the scope of the present disclosure to mount lower stop 164L on a neighboring portion of backrest 161.

As suggested in FIG. 4, the top motion limiter 164T of the headrest-motion controller 164 is mounted on the header panel 163M3 to lie above the I-shaped finger grip aperture 163I. It is also within the scope of the present disclosure to mount the top motion limiter 164T on a neighboring portion of the movable headrest 162.

As suggested in FIG. 4, bottom motion limiter 164B of headrest-motion controller 164 is mounted on footer panel 163M4 to lie below the I-shaped finger grip aperture 163I. It is also within the scope of the present disclosure to mount bottom motion limiter 164B on a neighboring portion of the movable headrest 162.

Top motion limiter 164T and upper stop 164U cooperate to act as a hard stop during upward movement of the movable headrest 162 away from the seat bottom 14 to communicate to the caregiver that the movable headrest 162 is located at its highest elevation on backrest 161. This also generally keeps the headrest 162 secured to backrest 161. This upper hard stop can be overridden for headrest removal owing to the configuration and intermanagement of the top motion limiter 164T and the companion upper stop 164U.

Bottom motion limiter 164B and lower stop 164L cooperate to act as a hard stop during downward movement of the movable headrest 162 toward seat bottom 14 to communicate to the caregiver that the movable headrest 162 is located at its lowest elevation on backrest 161. This also generally keeps the headrest 1626 secured to backrest 161. This lower hard stop can be overridden for headrest removal owing to the configuration and intermanagement of the top motion limiter 164T and the companion lower stop 163L.

Location of upper and lower stops 164U, 164L on headrest-motion guide track 163T keep the track 163T laying against the backrest 161 in order to maintain smooth motion of the movable headrest 162 relative to backrest 161. Also these upper and lower stops 164U, 164L function to keep the first and second strips 163S1, 163S2 of headrest-motion guide track 163T secured so they do not readily fold forward to release the headrest 162.

The movable headrest comprises a substantially rectangular core made of a plastics material and an outer covering made of a fabric material. The movable headrest 162 supports the head of an occupant seated on juvenile vehicle seat 10 and is coupled to headrest-motion guide track 163T to provide a generally flat surface along the seat back 16 during up-and-down movement of the headrest 162 relative to backrest 161. In an illustrative embodiment, headrest-height adjuster 163 is configured to provide about eight inches of travel of the movable headrest 162 between the raised and lowered positions.

Juvenile vehicle seat 10 comprises a seat bottom 14 and a seat back 16 as shown in FIG. 1. Seat back 16 includes a backrest 161 arranged to extend upwardly from seat bottom 14 and, a movable headrest 162. Seat back 16 also includes headrest-height adjuster means 163 for establishing a frictional interface 163F provided between at least two opposing surfaces located in a space 165 provided between between a front side 161F of backrest 161 and an opposing rear side 162R of the movable headrest 162 to allow manual up-and-down movement of the movable headrest 162 relative to backrest 161 between a raised position separated from seat bottom 14 by a first distance (D1) and a lowered position separated from seat bottom 14 by a relatively lesser second distance (D2) in response to application of an external friction-overcoming force (F) to the movable headrest 162 temporarily to overcome friction at frictional interface 163F and to retain the movable headrest 162 using friction extant at frictional interface 163F in a selected position among the raised position, the lowered position, and a continuum of intermediate positions between the raised and lowered positions once application of the external friction-overcoming force (F) has ceased.

Headrest-height adjuster means 163 includes a headrest-motion guide track 163T coupled to front side 161F of backrest 61 and a companion slidable guide-track mount 163M coupled to rear side 162R of the movable headrest 162. The slidable guide-track mount 163M is mated to headrest-motion guide track 163T to establish frictional interface 163F to allow selective up-and-down friction-overcoming movement of the movable headrest 162 relative to backrest 161 during exposure of the movable headrest 162 to the external friction-overcoming force (F).

Headrest-motion guide track 163T includes a first strip 163S1 and a rearwardly extending strip anchor 163A as suggested in FIGS. 5 and 6. First strip 163S1 is arranged to lie in a vertical orientation on an upper portion 161U of backrest 161. The rearwardly extending strip anchor 163A is coupled to an inner portion of the first strip 163S1 at an outer end and to the forwardly facing surface of the upper portion 161U of the backrest 161 at an opposite inner end to establish a vertically extending first side-opening panel-receiver slot 163T1 under first strip 163S1. The slidable guide-track mount 163M includes a first slide panel 163M1 that is tethered to rear side 162R of the movable headrest 162 for movement relative to the movable headrest 162 to allow a free end of first slide panel 163M1 to extend into the first side-opening panel-receiver slot 163T1 defined between first strip 163S1 and upper portion 161U of backrest 161 to establish a first portion of the frictional interface 163F between first strip 163S1 and first slide panel 163M1.

Frictional interface 163F is established by engagement of slidable guide-track mount 163M and headrest-motion guide track 163T as suggested diagrammatically in FIG. 1. The at least two surfaces that cooperate to provide the frictional interface 163F comprise a rearwardly facing surface of the first strip 163S1 that is arranged to face toward the backrest 161 and a forwardly facing surface of the first slide panel 163M1 that is arranged to face toward the movable backrest 162 and frictionally engage the rearwardly facing surface of the first strip 163S1.

Headrest-motion guide track 163T further includes a second strip 163S2 arranged to lie in side-by-side relation to the first strip 163S1 as also suggested in FIGS. 5 and 6. Outer end of the rearwardly extending strip anchor 163A is coupled to an inner portion of second strip 163S2 to establish a vertically extending second side-opening panel-receiver slot 163T2 under second strip 163S2. First and second side-opening panel-receiver slots 163T1, 163T2 open sideways in opposite directions to cause the first side-opening panel-receiver slot 163T1 to open in a first direction forward a first side 1161 of backrest 161 and the second side-opening panel-receiver slot 163T2 to open in an opposite second direction forward an opposite second side 1612 of backrest 161. The slidable guide-track mount 163M also includes a second slide panel 163M2 that is tethered to rear side 162R of the movable headrest 162 for movement relative to the movable headrest 162 to allow a free end of second slide panel 163M2 to extend toward free end of first slide panel 163M1 and into second side-opening panel-receiver slot 163T2 defined between second strip 163S2 and upper portion 161U of backrest 161 to establish a second portion of the frictional interface 163F between second strip 163S2 and second slide panel 163M2.

Seat back 16 further includes a headrest-motion controller 164 as suggested in FIGS. 1, 2, and 4. Headrest-motion controller 164 includes a top motion limiter 164T coupled to an upper portion 162U of the movable headrest 162, a bottom motion limiter 164B coupled to a lower portion 162L of the movable headrest 162 to locate the first side panel 163M1 therebetween, an upper stop 164U associated with the upper portion 161U of the backrest 161, and a lower stop 164L associated with a middle portion 161M of the backrest 161 and located between the upper stop 164U and the seat bottom 14. Upper stop 164U is arranged to engage the bottom motion limiter 164B during upward movement of the movable headrest 162 away from the seat bottom 14 and the lowered position so as to block further upward movement of the movable headrest 162 upon arrival of the movable headrest 162 at the raised position. Lower stop 164L is arranged to engage the top motion limiter 164T during downward movement of the movable headrest 162 toward the seat bottom 14 and away from the raised position so as to block further downward movement of the movable headrest 162 upon arrival of the movable headrest 162 at the lowered position. Each of the upper and lower stops 164U, 164L is coupled to the headrest-motion guide track 163T and arranged to locate the headrest-motion guide track 163T between the backrest 161 and the upper and lower stops 164U, 164L.

First slide panel 163M1 is mounted on the rear side 162R of the movable headrest 162 for pivotable movement about a vertically extending first pivot axis A1. Second slide panel 163M2 is mounted on the rear side 162R of the movable headrest 162 for pivotable movement about a vertically extending second pivot axis A2 to cause the free ends of the first and second slide panels 163M1, 163M2 to extend toward one another to form a vertically extending caregiver-finger insertion slot 163I3 therebetween. The rearwardly extending strip anchor 163A is arranged to extend through the vertically extending caregiver-finger insertion slot 163I3 during up-and-down movement of the movable headrest 162 relative to the backrest 161.

The slidable guide-track mount 163M further includes a header panel 163M3 coupled to the rear side 162R of the movable headrest 162 and a footer panel 163M4 coupled to the rear side 162R of the movable headrest 162 to lie in vertically spaced-apart relation to the header panel 163M3 to locate the first and second slide panels 161M1, 161M2 therebetween. The header, footer, and first and second slide panels 163M1-M4 cooperate to form an I-shaped aperture 163I opening toward backrest 161.

First and second slide panels 161M1, 161M2 of the slidable guide-track mount 161M cooperate with an opposing rearwardly facing portion of backrest 161 to form a strip-retainment space 162S and to provide means for allowing movement of first and second slide panels 161M1, 161M2 of the slidable guide-track mount 161M in strip-retainment space 162S relative to first and second strips 163S1, 163S2 of headrest-motion guide track 163T during up-and-down movement of the movable headrest 162 on headrest-motion guide track 163T. First and second slide panels 163M1, 163M2 are made of a pliable material to bend and flex during insertion into the first and second side-opening panel-receiver slots 163T1, 163T2 to facilitate movable headrest engagement to and disengagement from headrest-motion guide track 163T coupled to front side 161F of backrest 161.

Strip-retainment space 162S comprises a first strip-receiver channel 162C1 under first side panel 163M1 and a second strip receiver channel 162C2 under second slide panel 163M2 as suggested in FIG. 4. Each strip-receiver channel 162C1, 162C2 opens into I-shaped finger-grip aperture 163I as suggested in FIG. 4.

Headrest-motion guide track 163T is coupled to front side 161F of the backrest 161 and a slidable guide-track mount 163M is coupled to rear side 162R of the movable headrest 162 as suggested in FIGS. 3 and 4. The slidable guide-track mount 163M is mated to headrest-motion guide track 163T to allow up-and-down movement of the movable headrest 162 relative to backrest 161 in response to application of an external force (F) to the movable headrest 162 and to remain stationary relative to backrest 161 in any one of a raised position separated from seat bottom 14 by a first distance D1, a lowered position separated from the seat bottom 14 by a relatively lesser second distance D2, and a continuum of intermediate positions between the raised and lowered positions in response to cessation of the application of the external force (F) to the movable headrest 162.

Each of the headrest-motion guide track 163T and the slidable guide-track mount 163M is made of a pliable material to flex relative to each of the backrest 161 and the movable headrest 162 during mating of the slidable guide-track mount 163M to headrest-motion guide-track 163T. Headrest 162 is made of a flexible polypropylene material and an outer covering made of fabric. The slidable guide-track mount 163M is made of an elastic deformable material comprising a core made of a polypropylene material and an outer covering made of fabric.

1. A juvenile vehicle seat comprising
a seat bottom and
a seat back including a backrest arranged to extend upwardly from the seat bottom, a movable headrest, and headrest-height adjuster means for establishing a frictional interface provided between at least two opposing surfaces located in a space provided between a front side of the backrest and an opposing rear side of the movable headrest to allow manual up-and-down movement of the movable headrest relative to the backrest between a raised position separated from the seat bottom by a first distance and a lowered position separated from the seat bottom by a relatively lesser second distance in response to application of an external friction-overcoming force to the movable headrest temporarily to overcome friction at the frictional interface and to retain the movable headrest using friction extant at the frictional interface in a selected position among the raised position, the lowered position, and a continuum of intermediate positions between the raised and lowered positions once application of the external friction-overcoming force has ceased.

2. The juvenile vehicle seat of claim 1, wherein the headrest-height adjuster means includes a headrest-motion guide track coupled to the front side of the backrest and a companion slidable guide-track mount coupled to the rear side of the movable headrest and the slidable guide-track mount is mated to the headrest-motion guide track to establish the frictional interface to allow selective up-and-down friction-overcoming movement of the movable headrest relative to the backrest during exposure of the movable headrest to the external friction-overcoming force.

3. The juvenile vehicle seat of claim 2, wherein the headrest-motion guide track includes a first strip that is arranged to lie in a vertical orientation on an upper portion of the backrest and a rearwardly extending strip anchor coupled to an inner portion of the first strip at an outer end and to the forwardly facing surface of the upper portion of the backrest at an opposite inner end to establish a vertically extending first side-opening panel-receiver slot under the first strip and wherein the slidable guide-track mount includes a first slide panel that is tethered to the rear side of the movable headrest for movement relative to the movable headrest to allow a free end of the first slide panel to extend into the first side-opening panel-receiver slot defined between the first strip and the upper portion of the backrest to establish a first portion of the frictional interface between the first strip and the first slide panel.

4. The juvenile vehicle seat of claim 3, wherein the at least two surfaces that cooperate to provide the frictional interface comprise a rearwardly facing surface of the first strip that is arranged to face toward the backrest and a forwardly facing surface of the first slide panel that is arranged to face toward the movable backrest and frictionally engage the rearwardly facing surface of the first strip.

5. The juvenile vehicle seat of claim 3, wherein the seat back further includes a headrest-motion controller including a top motion limiter coupled to an upper portion of the movable headrest, a bottom motion limiter coupled to a lower portion of the movable headrest to locate the first side panel therebetween, an upper stop associated with the upper portion of the backrest, and a lower stop associated with a middle portion of the backrest and located between the upper stop and the seat bottom, wherein the upper stop is arranged to engage the bottom motion limiter during upward movement of the movable headrest away from the seat bottom and the lowered position so as to block further upward movement of the movable headrest upon arrival of the movable headrest at the raised position, and wherein the lower stop is arranged to engage the top motion limiter during downward movement of the movable headrest toward the seat bottom and away from the raised position so as to block further downward movement of the movable headrest upon arrival of the movable headrest at the lowered position.

6. The juvenile vehicle sat of claim 5, wherein each of the upper and lower stops is coupled to the headrest-motion guide track and arranged to locate the headrest-motion guide track between the backrest and the upper and lower stops.

7. The juvenile vehicle seat of claim 3, wherein the headrest-motion guide track further includes a second strip arranged to lie in side-by-side relation to the first strip, the outer end of the rearwardly extending strip anchor is coupled to an inner portion of the second strip to establish a vertically extending second side-opening panel-receiver slot under the second strip, the first and second side-opening panel-receiver slots open sideways in opposite directions to cause the first side-opening panel-receiver slot to open in a first direction forward a first side of the backrest and the second side-opening panel-receiver slot to open in an opposite second direction forward an opposite second side of the backrest, and the slidable guide-track mount also includes a second slide panel that is tethered to the rear side of the movable headrest for movement relative to the movable headrest to allow a free end of the second slide panel to extend toward the free end of the first slide panel into the second side-opening panel-receiver slot defined between the second strip and the upper portion of the backrest to establish a second portion of the frictional interface between the second strip and the second slide panel.

8. The juvenile vehicle seat of claim 7, wherein the first slide panel is mounted on the rear side of the movable headrest for pivotable movement about a vertically extending first pivot axis, the second slide panel is mounted on the rear side of the movable headrest for pivotable movement about a vertically extending second pivot axis to cause the free ends of the first and second slide panels to extend toward one another to form a vertically extending caregiver-finger insertion slot therebetween, and the rearwardly extending strip anchor is arranged to extend through the vertically extending caregiver-finger insertion slot during up-and-down movement of the movable headrest relative to the backrest.

9. The juvenile vehicle seat of claim 8, wherein the slidable guide-track mount further includes a header panel coupled to the rear side of the movable headrest and a footer panel coupled to the rear side of the movable headrest to lie in vertically spaced-apart relation to the header panel to locate the first and second slide panels therebetween and wherein the header, footer, and first and second slide panels cooperate to form an I-shaped aperture opening toward the backrest.

10. The juvenile vehicle seat of claim 7, wherein the first and second slide panels of the slidable guide-track mount cooperate with an opposing rearwardly facing portion of the backrest to form a strip-retainment space and to provide means for allowing movement of the first and second slide panels of the slidable guide-track mount in the strip-retainment space relative to the first and second strips of the headrest-motion guide track during up-and-down movement of the movable headrest on the headrest-motion guide track.

11. The juvenile vehicle seat of claim 7, wherein the first and second slide panels are made of a pliable material to bend and flex during insertion into the first and second side-opening panel-receiver slots to facilitate movable headrest engagement to and disengagement from the headrest-motion guide track coupled to the front side of the backrest.

12. The juvenile vehicle seat of claim 7, wherein the seat back further includes a headrest-motion controller including a top motion limiter associated with an upper portion of the movable headrest, a bottom motion limiter associated with a relatively lower lower portion of the movable headrest, an upper stop associated with the upper portion of the backrest, and a lower stop associated with a relatively lower middle portion of the backrest, wherein the upper stop is arranged to engage the bottom motion limiter during upward movement of the movable headrest away from seat bottom and the lowered position to block further upward movement of the movable headrest upon arrival of the movable headrest at the raised position, and wherein the lower stop is arranged to engage the top motion limiter during downward movement of the movable headrest toward the seat bottom and away from the raised position to block further downward movement of the movable headrest upon arrival of the movable headrest at the lowered position.

13. A juvenile vehicle seat comprises
a seat bottom and
a seat back including a backrest associated with the seat bottom, a movable headrest mounted for up-and-down movement relative to the backrest in directions toward and away from the seat bottom, and a headrest-height adjuster located between a front side of the backrest and a rear side of the movable headrest and configured to include a headrest-motion guide track coupled to a front side of the backrest and a slidable guide-track mount coupled to a rear side of the movable headrest and mated to the headrest-motion guide track to allow up-and-down movement of the movable headrest relative to the backrest in response to application of an external force to the movable headrest and to remain stationary relative to the backrest in any one of a raised position separated from the seat bottom by a first distance, a lowered position separated from the seat bottom by a relatively lesser second distance, and a continuum of intermediate positions between the raised and lowered positions in response to cessation of the application of the external force to the movable headrest.

14. The juvenile vehicle seat of claim 13, wherein each of the headrest-motion guide track and the slidable guide-track mount is made of a pliable material to flex relative to each of the backrest and the movable headrest during mating of the slidable guide-track mount to the headrest-motion guide-track.

15. The juvenile vehicle seat of claim 14, wherein the headrest is made of a flexible polypropylene material and an outer covering made of fabric.

16. The juvenile vehicle seat of claim 14, wherein the slidable guide-track mount is made of an elastic deformable material comprising a core made of a polypropylene material and an outer covering made of fabric.
